(19) United States
(12) Patent Application Publication
(10) Pub. No.: US 2019/0375089 A1
(43) Pub. Date: Dec. 12, 2019

(54) Portable Power Tool

(71) Applicant: Robert Bosch GmbH, Stuttgart (DE)

(72) Inventors: Cornelius Boeck, Kirchheim (DE); Daniel Barth, Leinfelden-Echterdingen (DE); Rainer Vollmer, Neuhausen (DE); Sinisa Andrasic, Schoenaich (DE); Manfred Lutz, Filderstadt (DE); Andreas Wolf, Stuttgart (DE); Peter Stierle, Pliezhausen (DE)

(21) Appl. No.: 16/476,831

(22) PCT Filed: Dec. 20, 2017
(86) PCT No.: PCT/EP2017/083861

§ 371 Date: Jul. 9, 2019

(30) Foreign Application Priority Data
Jan. 27, 2017 (DE) 10 2017 201 311.7

(51) Int. Cl. B25F 5/02; B24B 23/02

(52) U.S. Cl. CPC B25F 5/02; B24B 23/028

(57) ABSTRACT

A portable power tool, in particular an angle grinder, includes a housing that accommodates a drive and an electronic device with an interface configured to electrically connect the electronic device. The power tool further includes a housing inner part that is configured as a drive housing and supports the electronic device. The interface has at least one first electrical interface contact region and at least one second interface contact region spaced apart from the first interface contact region. At least one insulating element spaced apart from the interface contact regions is arranged between the housing inner part and the electronic device. The insulating element is configured to avoid an electrical short-circuiting connection between the first interface contact region and the second interface contact region.

The invention relates to a portable power tool, in particular an angle grinder, in accordance with the preamble of the first claim.

### PRIOR ART

Portable power tools having a housing and having an electronic unit accommodated in the interior of the housing are known from the prior art. This electronic unit is inserted in the housing in such a way that the electronic unit is held positively and/or nonpositively relative to the housing in the housing. Owing to manufacturing tolerances, it is not possible to prevent the formation of gaps between the electronic unit and the housing. These gaps can fill with contaminants.

### DISCLOSURE OF THE INVENTION

It is the underlying object of the invention to improve a portable power tool, in particular an angle grinder, by simple design measures.

The object is achieved by a portable power tool, in particular an angle grinder, comprising a housing, which has in particular at least one housing cover or one housing half-shell and in which a drive and an electronic device having an interface for electrically connecting the electronic device are accommodated, and a housing inner part, which is configured in particular as a drive housing and supports the electronic device, wherein the interface has at least one first electrical interface contact region and at least one second interface contact region spaced apart from the first interface contact region.

According to the invention, at least one insulating element spaced apart from the interface contact regions is arranged between the housing inner part and the electronic device, said insulating element being intended to avoid an electrical short-circuiting connection between the first interface contact region and the second interface contact region.

During machining of metal workpieces, for example, small metal chips/particles are separated from the workpiece and enter the proximate environment. These metal chips/particles can pass from the environment into the portable power tool by being sucked into air inlet openings in the portable power tool, for example, and entering the interior of the angle grinder together with cooling air that is cooling the portable power tool. During this process, the metal chips/particles can be deposited or settle in the interior of the portable power tool and thereby contaminate and clog the portable power tool.

Particularly in enterprises such as fettling shops, the users wear protective clothing and respiratory protection gear to protect themselves against the metal chips in the air and, in addition, seal their clothing off in the neck region, around the wrists and ankles with adhesive tape to ensure that the fine metal chips/particles circulating as metal dust in the ambient air cannot penetrate via the gaps between two adjacent pieces of clothing.

Since the metal chips/particles are generally good electric conductors, the metal chips/particles can lead to a short circuit if adjacent electrical interface contact regions become clogged with metal chips/particles. This can lead to the failure of components, with the formation, for example, of leakage currents within the device and the formation of an electrical connection between two adjacent interface contact regions, for example. Owing to manufacturing tolerances of two adjacent components to be installed within the portable power tool, gaps between the components to be installed generally can be expected. These manufacturing tolerances can lead to gaps filling with metal chips/particles.

The portable power tool can be designed as an angle grinder and can form a grinding, parting or polishing machine, for example.

The housing inner part can be intended to leave the components, e.g. the electronic device, exposed in an unassembled state and to support said components positively and/or nonpositively in the housing, in particular the housing inner part, in an assembled state. As part of manufacture, tolerances can arise between the inner part of the housing and the components, and these can form a gap between the components and the housing inner part.

The housing can be formed in one piece with the housing inner part. In an assembled state of the portable power tool, the housing inner part is surrounded by a further housing, in particular designed as a housing cover.

The interface of the electronic device is embodied as an electrical interface and is intended to allow an electrical connection to a power supply unit, e.g. a mains connector or an electrical power storage device designed as a battery pack. Electrical interfaces of this kind are part of the prior art and are sufficiently well known to a person skilled in the art, and therefore such interfaces will not be explained in greater detail.

Interfaces of this kind have at least two interface contact surfaces, which are intended to produce an electric current flow which flows through the electronic device at least in part when the electronic device is actuated and is transmitted at least in part to the second interface contact region from the first interface contact region, for example.

In particular, the interface contact regions can be exposed in an outer region of the electronic device. The interface contact regions can preferably project in an outer region of the electronic device in order to ensure good accessibility of the interface contact regions.

The interface contact regions are of electrically conductive design. The interface contact regions can contain a metal material or consist thereof.

The portable power tool can have leads which are connected to the interface contact regions and are intended to conduct electric current.

An “electronic device” is intended, in particular, to mean a device which influences at least one electric current in a gas, in a conductor, in a vacuum and/or, advantageously, in a semiconductor. The electronic device can preferably have at least one transistor, in particular at least one microprocessor. The electronic device can preferably have a switch.

In particular, the insulating element can be used, in the event of an accumulation of metal chips/particles within the housing, to increase a minimum possible distance between the metal chips and the interface contact regions by arranging the insulating element between the interface contact regions.

In particular, the insulating element can be formed in one piece or from a coherent part or can be formed in several parts or from a plurality of insulating elements arranged in series. In this case, the insulating elements can be designed as flat insulating strips. The insulating element can preferably be formed from a material through which it is impossible per se for dust, in particular metal dust, to flow, and therefore it is not possible for any metal chips/particles to pass through the insulating element.

In this context, an “insulating element” should be taken to mean, in particular, a layer which has a high insulation resistance and/or a low electrical conductivity. The insulating layer is preferably composed at least partially of a material which has a high insulation resistance. In this context, a “high insulation resistance” should be taken to mean a resistance of at least 50Ω, preferably of at least 300Ω and particularly preferably at least 500Ω. It is furthermore proposed that the insulating layer should be composed at least partially of an engineering plastic.

In particular, the insulating element can be flexible and compressible, and this should be taken, in particular, to mean an element which has at least one extent which, in a normal operating state, can vary flexibly by at least 10%, in particular by at least 20%, preferably by at least 30% and particularly preferably by at least 50% and which, in particular, produces a counterforce dependent on a change in the extent and preferably proportional to the extent, which counteracts the change. An “extent” of an element should be taken to mean, in particular, a maximum distance between two points in a vertical projection of the element onto a plane. It is thereby possible to compensate for tolerance differences between housing inner parts and the electronic device.

The dependent claims indicate expedient developments of the portable power tool according to the invention.

It may be expedient if the insulating element forms a first chamber region and a second chamber region, which is spaced apart from the first chamber region, at least in some section or sections, wherein the insulating element separates the first chamber region from the second chamber region, at least in some section or sections, along a plane which, in particular, extends parallel and/or orthogonally to a main direction of extent of the portable power tool, wherein the first chamber region has the first interface contact region, and the second chamber region has the second interface contact region. It is thereby possible to ensure that a minimum distance between the two interface contact regions is increased. A chamber should be taken to mean a gap which is bounded, at least in some section or sections, by the housing inner part and the electronic device, for example, and, in particular, is bounded at least in some section or sections between the insulating element and the chamber region. In particular, the chamber region can be formed as a gap between the housing inner part and the electronic device.

It may furthermore be expedient if the insulating element is designed as a filling element. In particular, the insulating element can be of elastically deformable design. As a preferred possibility, the filling element can be intended to fill a clearance between the housing inner part and the electronic device. As a result, the insulating element can separate or insulate the two interface contact regions from one another in a particularly simple way. It is furthermore thereby possible to achieve a preload between the housing inner part and the electronic device, thus enabling microvibrations between the electronic device and the housing inner part to be reliably damped.

Since the insulating element can be employed in existing portable power tools, an insulating element composed of a compressible material could be preferred. Alternatively, the insulating element can contain a material or be composed of a material which is less flexible than a material which the housing inner part contains or of which it is composed.

In particular, the insulating element can be provided between an electronic device and a magnetic wheel region, wherein the magnetic wheel region forms a region in the direct vicinity of the electric motor.

It may furthermore be expedient if the clearance has an extent between the housing inner part and the electronic device of less than 2 mm, in particular less than 1.5 mm, preferably less than 1.2 mm, preferably less than 1 mm, as a further preference less than 0.8 mm, and particularly preferably less than 0.6 mm. It is thereby possible to reduce or avoid gaps between the housing inner part and the electronic device.

The insulating element can extend between the housing inner part and the electronic device in such a way that the insulating element fills an extent of the clearance between the housing inner part and the electronic device, in particular completely. In this case, the insulating element can, in particular, be designed with a flexibility such as to ensure that the clearance between the housing inner part and the electronic device is filled.

The insulating element can preferably have a material aperture which extends through the entire material thickness of the insulating element and which can be designed, for example, as a slot. In this case, the material aperture can be completely surrounded by the insulating element. It is thereby possible to reduce assembly forces in the assembly of the electronic device with the housing inner part.

As an alternative, the insulating element can extend in such a way that the insulating element only partially fills an extent of the clearance between the housing inner part and the electronic device. In this case, the insulating element can have an extent between the housing inner part and the electronic device which is less than 1.5 mm, in particular less than 1.2 mm, preferably less than 1.0 mm, preferably less than 0.8 mm and as a further preference less than 0.6 mm and is intended to reduce or completely fill the clearance between the housing inner part and the electronic device.

It is furthermore proposed that the electronic device be designed as an electric on/off switch and/or as an electric open-loop and/or closed-loop control unit. An “open-loop and/or closed-loop control unit” should be taken to mean, in particular, a unit which has at least one electronic control system, which should, in particular, form a unit which has a processing unit and a memory unit as well as an operating program stored in the memory unit.

It may furthermore be expedient for the insulating element to surround the electronic device, in particular an on/off switch, in a C shape. In particular, the insulating element can delimit at least three sides of the electronic device in at least one plane. It may furthermore be expedient for the insulating element to surround the electronic device, in particular the on/off switch, in an L shape and, in particular, to delimit at least two sides of the electronic device in at least one plane. The insulating element can preferably be arranged on the electronic device in such a way that the insulating element extends at least substantially in a direction away from the interface contact regions. It is thereby possible to separate the interface contact regions from one another in a particularly effective manner. The electronic device designed as an on/off switch may expediently have a switch actuating element designed as a push button, which is intended to actuate the on/off switch. As a preferred option, the interface contact regions can be arranged on a side of the on/off switch facing away from the switch actuating element.

It is proposed that a further insulating element, which is intended to avoid an electrical short-circuiting connection between the first interface contact region and the second interface contact region, be arranged between the housing inner part and the electronic device, in particular an open-loop and/or closed-loop control unit. It is thereby possible to prevent an accumulation of metal chips.

It is furthermore proposed that the insulating element be designed as an integral shaped stamped part, which, in particular, contains or consists of a foam, preferably a PU foam. In particular, the insulating element can contain or consist of a plastics material and, preferably, a material such as TPE or NBR can be used as the plastics material. As a preferred option, the insulating element can have a material thickness of more than 0.8 mm, in particular more than 1 mm. In this case, a plastics material such as moss rubber with a material thickness of about 1.2 mm can be used. In particular, the insulating element can be of T-shaped design, preferably forming a T shape from two separate insulating strips. As a result, the insulating element can be of particularly simple design.

It may be expedient if the insulating element is designed as a film which has at least one film surface having a self-adhesive layer for connecting the film to the housing inner part and/or the electronic device. In particular, the insulating element can be bonded onto a housing inner part and/or the electronic device, in particular by means of the self-adhesive layer. As an alternative, the insulating element can be placed on the housing inner part, with the result that the insulating element is held nonpositively or clamped between the housing inner part and the electronic device. As an alternative, the insulating element can be molded onto the housing inner part or onto the electronic device. As a further alternative, the insulating element can be foamed onto the housing inner part or onto the electronic device. It is thereby possible to produce the portable power tool in a particularly simple manner.

It may furthermore be expedient if the electronic device, in particular an on/off switch, has a first labyrinth seal element, and the housing inner part has a second labyrinth seal element. In particular, the insulating element can be arranged in or on the first and/or second labyrinth seal element and can be intended to prevent material transport. In particular, the first labyrinth seal element can be designed as a sealing groove. The second labyrinth seal element can preferably be designed as a sealing protrusion. The first and/or the second labyrinth seal element can be intended to form a labyrinth seal. Through the combination of a labyrinth seal with the insulating element, material transport, e.g. of metal dust containing metal chips, can be avoided.

### BRIEF DESCRIPTION OF THE DRAWINGS

Further advantages will become apparent from the following description of the drawing. The drawing illustrates illustrative embodiments of the invention. The drawings, the description and the claims contain numerous features in combination. A person skilled in the art will also expediently consider the features individually and combine them into worthwhile further combinations. In the drawing:

FIG. 1 shows a perspective view of a portable power tool,

FIG. 2 shows a segment of a cross section of the portable power tool shown in FIG. 1,

FIG. 3 shows a cross section of the portable power tools shown in FIG. 1,

FIG. 4 shows a view of an electronic device,

FIG. 5 shows another view of the electronic device,

FIG. 6 shows a perspective view of the electronic device,

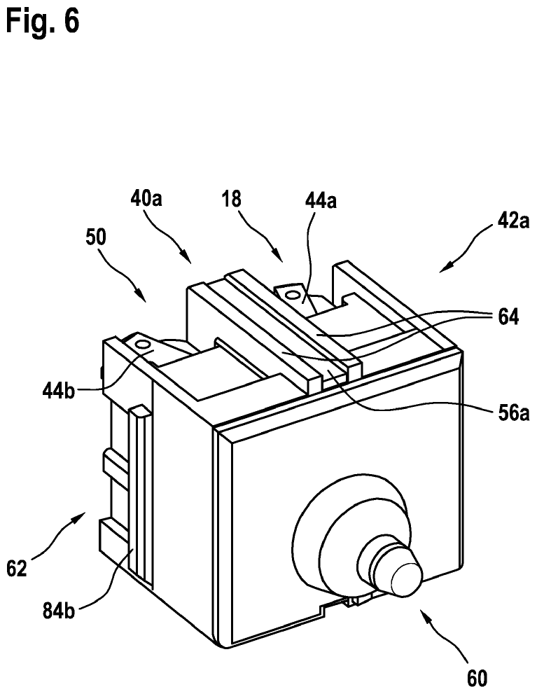

FIG. 7 shows a perspective view of a housing frame,

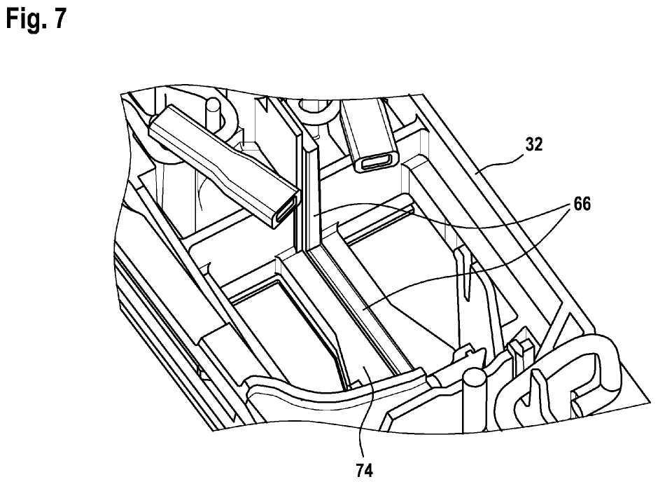

FIG. 8 shows another view of a housing frame,

FIG. 9 shows another view of a housing frame, and

FIG. 10 shows another view of a housing frame.

In the following figures, identical components are provided with the same reference signs.

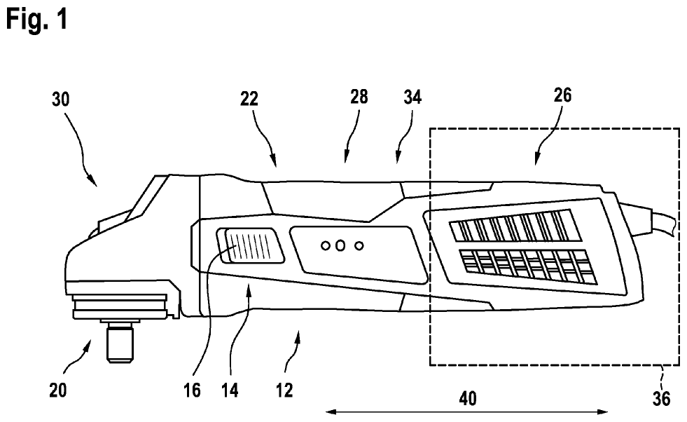

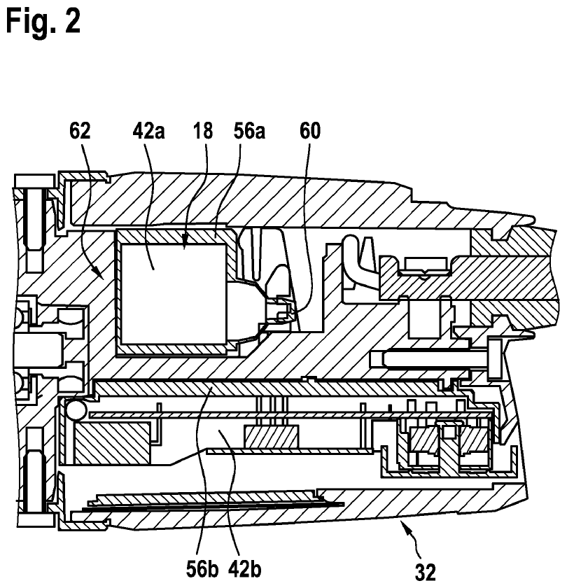

FIG. 1 shows a portable power tool 12, which is formed by portable power tool 12 designed as an angle grinder. The portable power tool 12 comprises at least one switch unit 14, which has at least one actuating device 16 for actuation of at least one electric switch unit 18 (FIG. 2). A drive motor (not shown), which can be switched on and off by means of the switch unit 18, for driving a tool chuck 20 around a housing 22 is furthermore provided. The housing 22 extends along a direction of longitudinal extent 40 of the portable power tool 12.

The portable power tool 12 furthermore comprises a grip housing 26 designed as a housing cover, a drive housing 28 designed as a drive housing, and an output housing 30. In an alternative embodiment, however, the housing parts (26, 28) can be of single-part or integral design. The drive housing 28 has a housing inner part 32, which extends in the direction of the grip housing 26 and, in a state in which it is connected to the grip housing 26, is surrounded by the grip housing 26 designed as a housing cover.

Starting from a region of attachment 34 of the grip housing 26 to the drive housing 28, the grip housing 26 extends at least substantially in a direction of the grip housing 26 away from the region of attachment 34, in which a cable of the portable power tool 12 is arranged for the purpose of supplying power.

Suitable power tools here include both a fixed power tool, e.g. a bench saw in accordance with applications DE 102010042016 or U.S. Pat. No. 2,062,969 A and a non-fixed, portable power tool, e.g. a circular hand saw in accordance with application DE 3740200 A1 or, for example, a brush cutter that can be worn on the back, in accordance with application DE 19616764 A1.

FIG. 2 shows part of a cross section of the portable power tool through the plane 36 shown in FIG. 1. A drive (not shown) and two electronic devices 38a, 38b, each having an interface 40a, 40b for electrically connecting the electronic devices 38a, 38b, are accommodated in the housing 22. The drive housing 28 is formed in one piece with the housing inner part 32. In an assembled state of the portable power tool 12, the housing inner part 32 is surrounded by the grip housing 26. The housing inner part 32 of the drive housing 28 is intended to support an electronic device 38a, 38b in that the drive housing 28 at least partially surrounds the electronic devices 38a, 38b. The housing inner part 32 is intended to leave the electronic devices 38a, 38b exposed in an unassembled state of the portable power tool 12 and to support them positively and nonpositively in the housing inner part 32 in an assembled state. The housing inner part 32 is designed as a housing frame.

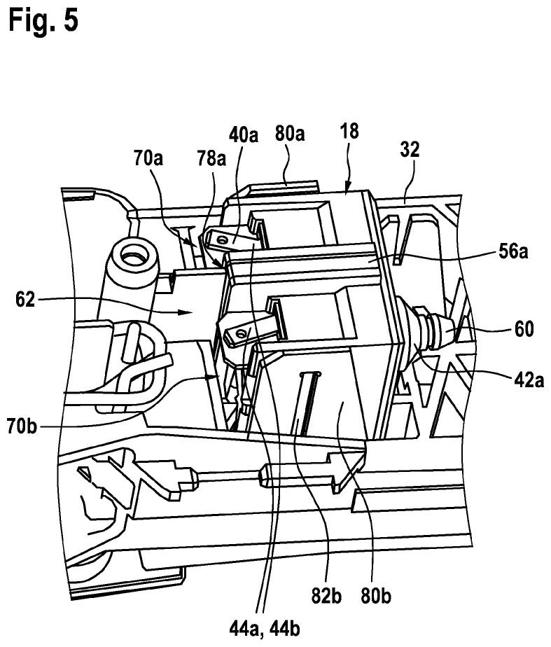

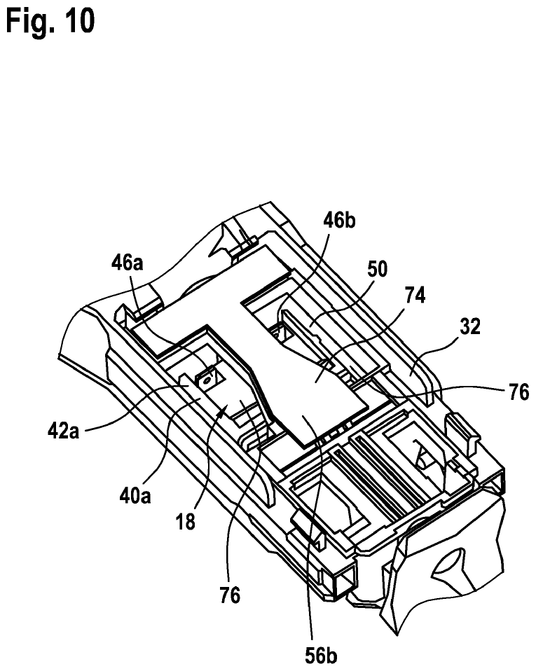

The portable power tool 12 has two electronic devices 38a, 38b. One of the electronic devices 38a is designed as an on/off switch 42a. The interface 40a of the on/off switch 42a has four interface contact regions 44a, 44b, 46a, 46b (FIG. 5, FIG. 10). The four interface contact regions 44a, 44b, 46a, 46b are divided into a first interface contact region 44a and a second interface contact region 44b, which transmit an electric current from the on/off switch 42a, in particular directly, to the drive unit by means of two leads 48a, 48b, and into an additional first interface contact region 46a (FIG. 10) and an additional second interface contact region 46b (FIG. 10), which form an electrical connection to a further electronic device 38a. The interface contact regions 44a, 44b, 46a, 46b of the on/off switch 42a are arranged in an outer region 50 of the on/off switch 42a and are exposed in the outer regions 50 of the on/off switch 42a. The interface contact regions 44a, 44b, 46a, 46b protrude in the outer regions 50 of the on/off switch 42a in order to ensure good accessibility of the interface contact regions 44a, 44b, 46a, 46b.

The further electronic device 42b is designed as an open-loop and/or closed-loop control unit 42b. The interface 40b of the open-loop and/or closed-loop control unit 42b has at least one further first electrical interface contact region 52a and at least one further second interface contact region 52b spaced apart from the further first interface contact region 52a. The interface contact regions 52a, 52b are arranged in an outer region of the electronic device 42b and are exposed in the outer region 54 of the open-loop and/or closed-loop control unit 42b. The interface contact regions 52a, 52b protrude in the outer region 54 of the open-loop and/or closed-loop control unit 42b in order to ensure good accessibility of the interface contact regions 52a, 52b.

The additional interface contact regions 46a, 46b are designed as plug connectors and are intended to form an electrical connection to the further interface contact regions 52a, 52b, which are designed as plug sockets.

The portable power tool 12 has an insulating element 56a, which is arranged between the housing inner part 32 and the on/off switch 42a. The insulating element 56a is arranged at a distance from the interface contact regions 44a, 44b, 46a, 46b. The insulating element 56a is intended to avoid an electrical short-circuiting connection between the first interface contact region 44a and the second interface contact region 44b.

The portable power tool 12 has a further insulating element 56b, which is arranged between the housing inner part 32 and the open-loop and/or closed-loop control unit 42b. The further insulating element 56b is arranged at a distance from the further interface contact regions 46a, 46b. The further insulating element 56b is intended to avoid an electrical short-circuiting connection between the further first interface contact region 46a and the further second interface contact region 46b.

The insulating element 56a, 56b is formed in one piece or from a coherent part. The insulating element 56a, 56b is designed as a filling element. The insulating element 56a, 56b is designed to be elastically deformable. The insulating element 56a, 56b is designed as a one-piece shaped stamped part. The insulating element 56a, 56b contains a PU foam or consists thereof. The further insulating element 56b is of T-shaped design (FIG. 10). The insulating element 56a, 56b is designed as a film which has at least one film surface having a self-adhesive layer for connecting the film to the housing inner part 32 and/or to the on/off switch 42a or open-loop and/or closed-loop control unit 42b. The insulating element 56a, 56b is bonded onto a housing inner part 32 by means of the self-adhesive layer. As an alternative or in addition, the insulating element 56a, 56b can be bonded onto the electronic device 42a, 42b by means of the self-adhesive layer.

The insulating element 56a, 56b is intended to fill a clearance 58a, 58b between the housing inner part 32 and the electronic device 42a 42b or the on/off switch 42a and/or the open-loop and/or closed-loop control unit 42b in order to prevent deposition of metal chips in the clearance 58a, 58b. The clearance 58a, 58b has an extent of less than 1.2 mm between the housing inner part 32 and the on/off switch 42a or the open-loop and/or closed-loop control unit 42b.

The insulating element 56a, 56b is designed to be elastically deformable. The insulating element 56a, 56b has a material thickness which is greater than the clearance 58a, 58b between the housing inner part 32 and the on/off switch 42a or the open-loop and/or closed-loop control unit 42b, with the result that the insulating element 56a, 56b completely fills the clearance 58a, 58b. The insulating element 56a, 56b has a material thickness of about 0.8 or 0.6 mm.

The insulating element 56a is of C-shaped design and surrounds the on/off switch 42a. The insulating element 56a, 56b delimits at least three sides of the on/off switch 42a in at least one plane 36. The insulating element 56a is arranged on the on/off switch 42a in such a way that the insulating element 56a, 56b extends at least substantially in a direction away from the interface contact regions 44a, 44b, 46a, 46b.

The on/off switch 42a has a switch actuating element 60 designed as a push button, which is intended to actuate the on/off switch 42a. The interface contact regions 44a, 44b, 46a, 46b are arranged on a drive side 62 of the on/off switch 42a, said side facing away from the switch actuating element 60.

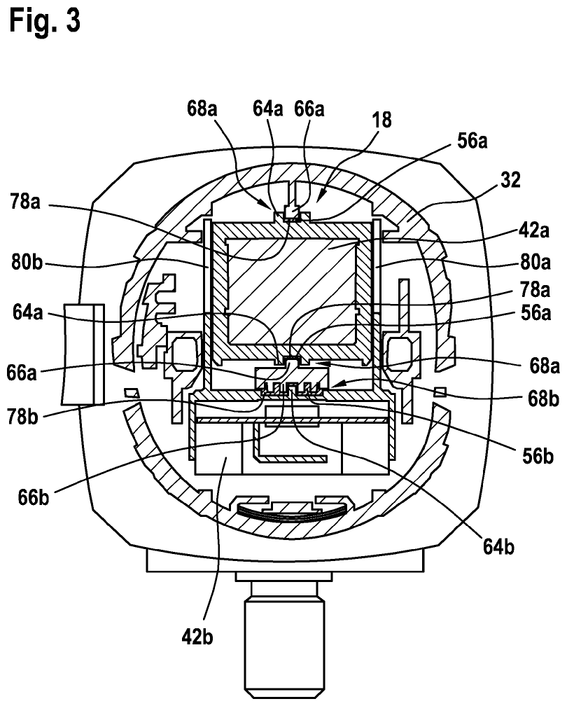

The on/off switch 42a has a first labyrinth seal element 64a (FIG. 3). The housing inner part 32 has a second labyrinth seal element 66a. The insulating element 56a is arranged in or on the first labyrinth seal element 64a and is intended to prevent material transport of metal chips. In particular, the first labyrinth seal element 64a can be designed as a sealing groove. The second labyrinth seal element 66a is designed as a sealing protrusion. The first and/or the second labyrinth seal element 64a, 66a are/is intended to form a mutually corresponding labyrinth seal 68a. Through the combination of a labyrinth seal 68a with the insulating element 58a, material transport, e.g. of metal dust containing metal chips, can be avoided.

Similarly to the labyrinth seal 68a, the housing inner part 32 can have a further labyrinth seal 68b, which has a further first labyrinth seal element 64b on the open-loop and/or closed-loop control unit 42b, said element being designed as a sealing groove and/or as a sealing protrusion, and a further second labyrinth seal element 66b on the housing inner part 32, said element being designed as a sealing protrusion and/or sealing groove.

The insulating element 56a, 56b is designed as a flat insulating strip. The insulating element 56a, 56b is formed from a material through which it is impossible per se for dust, in particular metal dust, to flow, and therefore it is not possible for any metal chips/particles to pass through the insulating element 56a, 56b.

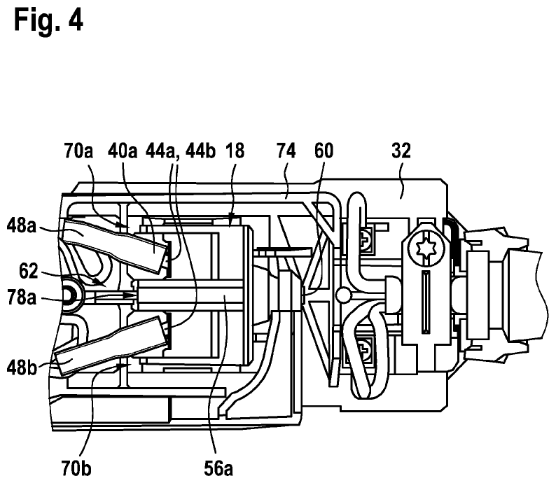

In FIG. 4 and FIG. 5, the insulating element 56a, 56b forms a first chamber region 70a and a second chamber region 70a spaced apart from the first chamber region 70a, at least in some section or sections. The insulating element 56a, 56b separates the first chamber region 70a from the second chamber region 70b, at least in some section or sections, along a plane 36 which extends parallel to a main direction of extent 40 of the portable power tool 12. The first chamber region 70a has the first interface contact region 44a. The second chamber region 70b has the second interface contact region 44b.

Any properties and embodiments of the insulating element 56a which have been described are also intended to be applicable to the further insulating element 56b.

The portable power tool 12 has at least one lead (not shown), which is intended to carry electric current between the interface contact regions 44a, 44b and the additional interface contact regions 52a, 52b.

The on/off switch 42a is arranged on a first side of the housing inner part 32, and the open-loop and/or closed-loop control unit 42b is arranged on a second side of the housing inner part, which faces away from the first side. In an assembled state of the portable power tool 12, the additional interface contact regions 46a, 46b of the on/off switch 42a make contact with the further interface contact regions 52a, 52b of the open-loop and/or closed-loop control unit 42b. The on/off switch 42a and the open-loop and/or closed-loop control unit 42b are arranged opposite one another in an assembled state.

In an assembled state of the portable power tool 12, the further interface contact regions 52a, 52b of the open-loop and/or closed-loop control unit 42b are separated by a housing frame 74 of the housing inner part 32. In an assembled state, the further interface contact regions 52a, 52b each extend through two apertures 76 in the housing inner part 32, which are separated by the housing frame 74.

The further insulating element 56a, 56b is arranged substantially on the housing frame 74 of the housing inner part 32 and fills a clearance 78a, 78b between the open-loop and/or closed-loop control unit 42b and the housing frame 74 of the housing inner part 32.

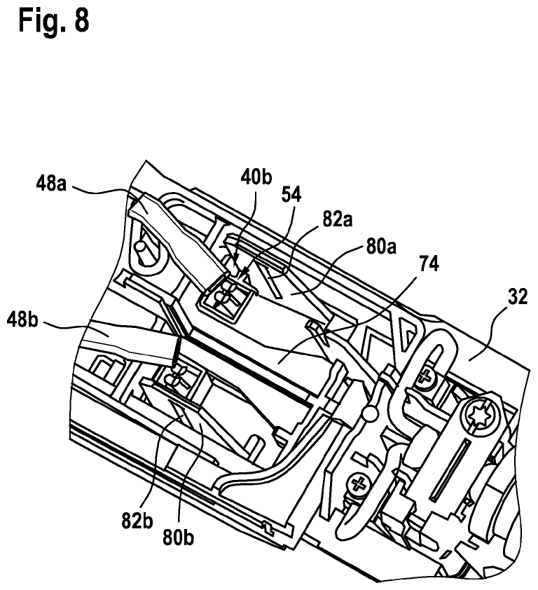

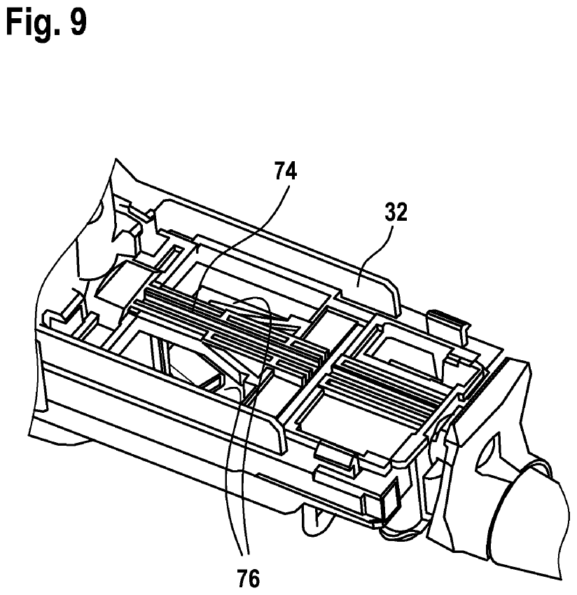

The open-loop and/or closed-loop control unit 42b furthermore has two projecting holding arms 80a, 80b (FIG. 8), which each extend through the apertures 76 (FIG. 9) in the housing inner part 32 in an assembled state. The holding arms 80a, 80b each have a holding groove 82a, 82b, which is intended to interact with holding protrusions 84a, 84b (FIG. 8) of the on/off switch 42a in order to fix the on/off switch 42a relative to the open-loop and/or closed-loop control unit 42b. The holding arms 80a, 80b are designed as snap-fit arms.

In particular, the insulating element 56a, 56b can be provided between an electronic device and a magnetic wheel region, wherein the magnetic wheel region forms a region in the direct vicinity of the electric motor.

1. A portable power tool, comprising:
a housing having at least one of a housing cover or a housing half-shell;
a drive and an electronic device having an interface configured to electrically connect the electronic device are accommodated in the housing; and
a housing inner part that is configured as a drive housing and supports the electronic device,
wherein the interface has at least one first electrical interface contact region and at least one second interface contact region spaced apart from the first interface contact region and
wherein at least one insulating element spaced apart from the interface contact regions is arranged between the housing inner part and the electronic device, the insulating element configured to avoid an electrical short-circuiting connection between the first interface contact region and the second interface contact region.

2. The portable power tool as claimed in claim 1, wherein:
the insulating element forms a first chamber region and a second chamber region, which is spaced apart from the first chamber region, at least in one section,
the insulating element separates the first chamber region from the second chamber region, at least in one section, along a plane, and
the first chamber region has the first interface contact region, and the second chamber region has the second interface contact region.

3. The portable power tool as claimed in claim 1, wherein the insulating element is configured as a filling element and is elastically deformable, and wherein the filling element is configured to fill a clearance between the housing inner part and the electronic device.

4. The portable power tool as claimed in claim 3, wherein the clearance has an extent between the housing inner part and the electronic device of less than 2 mm.

5. The portable power tool as claimed in claim 1, wherein the electronic device is configured as one or more of an electric on/off switch, an electric open-loop control unit, and an electric closed-loop control unit.

6. The portable power tool as claimed in claim 1, wherein the insulating element surrounds the electronic device, in an L shape or C shape and delimits at least two sides or at least three sides of the electronic device in at least one plane.

7. The portable power tool as claimed in claim 1, wherein at least one further insulating element, which is configured to avoid an electrical short-circuiting connection between the first interface contact region and the second interface contact region, is arranged between the housing inner part and the electronic device.

8. The portable power tool as claimed in claim 1, wherein the insulating element is configured as an integral shaped stamped part that includes a foam.

9. The portable power tool as claimed in claim 1, wherein the insulating element is configured as a film with at least one film surface having a self-adhesive layer configured to connect the film to one or more of the housing inner part and the electronic device.

10. The portable power tool as claimed in claim 1, wherein:
the electronic device has a first labyrinth seal element configured as a sealing groove,
the housing inner part has a second labyrinth seal element configured as a sealing protrusion, and
the insulating element is (i) arranged in or on one or more of the first labyrinth seal element and the second labyrinth seal element and (ii) configured to prevent material transport of metal chips.

11. The portable power tool as claimed in claim 1, wherein the portable power tool is configured as an angle grinder.

12. The portable power tool as claimed in claim 2, wherein the plane extends one or more of (i) parallel to a main direction of extent of the portable power tool and (ii) orthogonally to the main direction of extent of the portable power tool.

13. The portable power tool as claimed in claim 4, wherein the extent of the clearance is less than 0.6 mm.

14. The portable power tool as claimed in claim 5, wherein the insulating element surrounds the on/off switch in an L shape or C shape and delimits at least two sides or at least three sides of the electronic device in at least one plane.

15. The portable power tool as claimed in claim 7, wherein the electronic device is configured as one or more of an open-loop control unit and a closed-loop control unit, and wherein the at least one further insulating element is arranged between the housing inner part and the one or more of the open-loop control unit and the closed-loop control unit.

16. The portable power tool as claimed in claim 8, wherein the foam is a PU foam.

17. The portable power tool as claimed in claim 10, wherein the electronic device is configured as an on/off switch.
